(19) United States
(12) Patent Application Publication
(10) Pub. No.: US 2023/0027271 A1
(43) Pub. Date: Jan. 26, 2023

(54) SILICON PHOTONICS CHIP-BASED LIDAR

(71) Applicant: United Microelectronics Center Co., Ltd, Chongqing (CN)

(72) Inventors: Li JIN, Chongqing (CN); Rui CAO, Chongqing (CN); Junbo FENG, Chongqing (CN); Zuwen LIU, Chongqing (CN); Ping JIANG, Chongqing (CN); Jin GUO, Chongqing (CN); Youxi LU, Chongqing (CN); Qixin LIU, Chongqing (CN); Mijie YANG, Chongqing (CN); Tonghui LI, Chongqing (CN)

(73) Assignee: United Microelectronics Center Co., Ltd, Chongqing (CN)

(21) Appl. No.: 17/788,313

(22) PCT Filed: Jul. 22, 2020
(86) PCT No.: PCT/CN2020/103518

§ 371 Date: Jun. 23, 2022

(30) Foreign Application Priority Data
Dec. 24, 2019 (CN) 201911344165X

(51) Int. Cl. G01S 7/481; G01S 17/58; G01S 17/06

(52) U.S. Cl. CPC G01S 7/4814; G01S 17/58; G01S 17/06

(57) ABSTRACT

A silicon photonic chip-based LiDAR, comprising a silicon photonic chip (2), a laser module, a beam collimator module (4), and a signal processing module (6), where the laser outputs a frequency modulated continuous laser and transmits the frequency modulated continuous laser to the silicon photonic chip (2), where the laser is split and transmitted in the silicon photonic chip (2) to form a reference interference light and a local oscillation light on the one hand, and the split laser is transmitted to the target (5) via the beam collimator module (4), and then the reflect light of the reference interference light is received to interfere with the local oscillation light to form a measurement interference light on the other hand; and the reference interference light and the measurement interference light are photoelectrically detected in the silicon photonic chip (2) and form an electrical signal being output to the signal processing module (6) to obtain the distance and speed of the target. The silicon photonic chip (2) integrates most of fiber transmission optical paths, coupling devices, and an optical detector, making the LiDAR system highly integrated and miniaturized. Therefore, a silicon photonic chip based LiDAR is characterized by high integration, small size, light weight, simple manufacture, and superior system stability and reliability.

### CROSS REFERENCE TO RELATED APPLICATION

The present application claims the benefit of priority to Chinese Patent Application No. CN 201911344165.X, entitled “SILICON PHOTONICS CHIP-BASED LIDAR”, filed with CNIPA on Dec. 24, 2019, the disclosure of which is incorporated herein by reference in its entirety.

### FIELD OF TECHNOLOGY

The present invention relates to a LiDAR, and specifically to a silicon photonics chip-based LiDAR.

### BACKGROUND

At present, laser modulation technology and narrow linewidth laser technology have become mature, and frequency modulated continuous wave (FMCW) LiDAR system is widely used in the field of distance and speed measurement, due to its advantages of strong ability against interference, less transmitting energy, easy modulation, low cost, simple signal processing and the like. The FMCW LiDAR system transmits frequency modulated continuous wave and interferes a transmitted local oscillation signal with a received echo signal to obtain a frequency difference signal, and then to measure the distance and speed employing the frequency difference signal.

Currently, frequency modulated continuous wave three-beam all-fiber LiDAR is used for distance and speed measurement, where reference light, measured local oscillation light, and echo signal light are coupled into the fiber, and the distance and speed information are obtained by interference and detection through fiber transmission. The presence of minimum bend radius of fiber and size limitation of various fiber devices cause the existing all-fiber LiDAR to have low integration, low compact structure, and low environmental stability. In recent years, due to the development of silicon-based optoelectronics, the technology of integrating optical devices on silicon has also become an area of interest for researchers. Current integrated optical devices in the field of LiDAR only take advantage of the small bend radius, low power consumption, and high power capacity of silicon, the optical devices are manufactured respectively on silicon, and then are integrated through a multi-chips system linkage. Although this integration method improves the electrical connection between the main optical components of LiDAR, the structure is still not compact, and there are also some optical components in the state of disconnection and short connection caused by the bad environment of connection and packaging, resulting in unstable operation of the LiDAR system.

### SUMMARY

The present invention provides a silicon photonics chip and a silicon photonics chip-based LiDAR, which improve integration and environmental stability of the LiDAR system, and alleviate the limitation of system size.

The present disclosure provides the following technical solution:

A silicon photonic chip, comprising a silicon body in which a beam splitter module, a light measurement interference module, an optical modulation interference module and a light detection module are integrated, where the beam splitter module is configured to receive an external input signal light and split the signal light to transmit them to the optical modulation interference module and the light measurement interference module; the light measurement interference module is configured to split the received signal light into a measurement light and a local oscillation light, and then receive reflected light of a portion of the measurement light to interfere with the local oscillation light to form a measurement interference light after transmitting the measurement light to the outside; the optical modulation interference module splits the received signal light into a first reference light and a second reference light, and then combines and interferes the first reference light and the second reference light after adjusting the optical phase of the first reference light and/or the second reference light to form a reference interference light; the light detection module receives the measurement interference light and the reference interference light respectively, and performs photoelectric conversion to output an electrical signal to the outside.

The present invention further provides a silicon photonic chip-based LiDAR, comprising the above silicon photonic chip, a laser module, a beam collimator module, and a signal processing module, where the output of the laser module is optically connected to the input of the silicon photonic chip, and the electrical signal output of the silicon photonic chip is electrically connected to the signal processing module to process and analyze laser measurement information; the beam collimator module is set on a side of the exit of the measurement light of the silicon photonic chip and allows the silicon photonic chip to be placed in the focal plane of the beam collimator module.

The present disclosure has the following beneficial effects:

The silicon photonic chip provided in the present invention integrates the beam splitter module, the light measurement interferometer module, the optical modulation interferometer module, and the optical detection module into the same silicon body to form a chip-level system for transmitting signal light, the present invention improves the stability and reliability of each optical component, reduces the noise of the system, obtains a more compact chip integration system, and meets the current requirements for miniaturization of LiDAR.

The silicon photonic chip-based LiDAR provided in the present invention adopts an integrated silicon photonic chip, thus greatly improving system integration, reducing system size and weight, improving system stability and reliability, reducing production costs, and easing assembly difficulties.

Other advantages, objectives, and features of the present invention will be embodied in part by the following description, and will be understood by those skilled in the art through the study and practice of the present invention in part.

### BRIEF DESCRIPTION OF THE DRAWINGS

FIG. 1 shows a schematic diagram of a LiDAR system according to the present disclosure.

In the figure:
laser 101,
isolator 102,
silicon photonics chip 2,
first grating coupler 201,
first splitting coupler 202,
optical modulation interference module 203,
first balance detector 204,
second splitting coupler 205,
second grating coupler 206,
third grating coupler 207,
fourth grating coupler 208,
fifth grating coupler 209,
optical switch 210,
transmitting and receiving grating unit 211,
second balance detector 212,
optical loop module 3,
beam collimator module 4,
target 5,
signal processing module 6.

### DETAILED DESCRIPTION

The present invention is described in detail in combination with the accompanying drawings of the description, and specific embodiments are given.

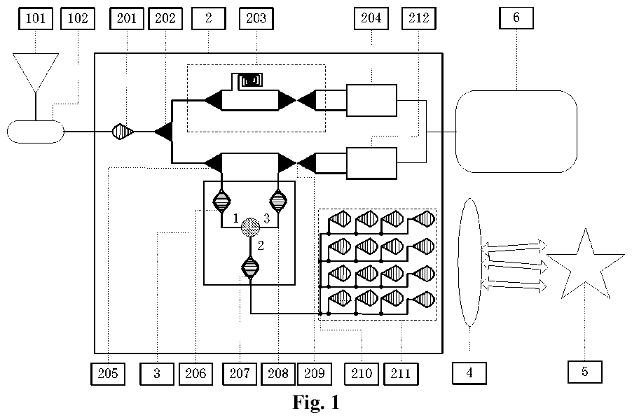

Referring to FIG. 1, the present invention provides a silicon photonics chip, comprising a silicon body in which a beam splitter module, a light measurement interference module, an optical modulation interference module 203 and a light detection module are integrated, where the beam splitter module is used to receive an external input signal light and split the signal light to transmit them to the optical modulation interference module 203 and the light measurement interference module; the light measurement interference module is used to split the received signal light into a measurement light and a local oscillation light, and then receive reflected light of a portion of the measurement light to interfere with the local oscillation light to form a measurement interference light after transmitting the measurement light to the outside; the optical modulation interference module 203 splits the received signal light into a first reference light and a second reference light, and then combines and interferes the first reference light and the second reference light after adjusting the optical phase of the first reference light and/or the second reference light to form a reference interference light; the light detection module receives the measurement interference light and the reference interference light respectively, and performs photoelectric conversion to output an electrical signal to the outside.

An optical path is integrated into the silicon body for the beam splitter module, the light measurement interference module, the optical modulation interference module 203, and the light detection module to transmit the signal light, and the optical path uses optical fiber or optical waveguide to transmit the signal light.

The beam splitter module comprises a first grating coupler 201 and a first splitting coupler 202; the first grating coupler 201 is configured to receive the external input signal light, and the output of the first grating coupler 201 is optically connected to the input of the first splitting coupler 202; the output of the first splitting coupler 202 is optically connected to the input of the optical modulation interference module 203 and the light measurement interference module, respectively.

The light measurement interference module comprises a second splitting coupler 205, an optical loop module 3, a fifth grating coupler 209 and a transmitting and receiving grating unit 211; the input of the second splitting coupler 205 is optically connected to the output of the first splitting coupler 202, the output of the second splitting coupler 205 is optically connected to a first port of the optical loop module 3 and to one of the inputs of the fifth grating coupler 209 respectively; a second port of the optical loop module 3 is optically connected to the input of the transmitting and receiving grating unit 211, a third port of the optical loop module 3 is optically connected to another input of the fifth grating coupler 209; the output of the fifth grating coupler 209 is optically connected to the input of the light detection module; and the transmitting and receiving grating unit 211 is configured to transmit the measurement light and to receive or transmit the reflected light of a portion of the measurement light.

The optical loop module 3 further comprises a second grating coupler 206, a third grating coupler 207, a fourth grating coupler 208, and an optical circulator; a first port of the optical circulator is optically connected to the second grating coupler 206 to form a first port of the optical loop module 3, a second port of the optical circulator is optically connected to the third grating coupler 207 to form a second port of the optical loop module 3, a third port of the optical circulator is optically connected to the fourth grating coupler 208 to form a third port of the optical loop module 3; the optical loop module 3 is optically connected to the second splitting coupler 205, the transmitting and receiving grating unit 211 and the fifth grating coupler 209 respectively through the second grating coupler 206, the third grating coupler 207 and the fourth grating coupler 208.

The optical modulation of the optical modulation interference module 203 comprises one of electro-optic modulation, thermo-optic modulation, or acousto-optic modulation. The optical modulation may be also achieved through modulating the phase of light differently, in which optical range difference is caused by two optical paths with different lengths. The latter optical modulation leads to a simple design structure and easy manufacturing, although the phase difference is fixed for the light of fixed frequency, due to the optical range difference is fixed resulting from the fixed structure, the detection of laser nonlinear errors can still be achieved by interfering with beat frequency signal for frequency modulated continuous laser. In contrast, electro-optic modulation, thermo-optic modulation, or acousto-optic modulation can adjust phase difference more flexibly, bring about more redundancy for manufacturing accuracy and more flexible application of silicon photonic chips. A Mach-Zender interferometer may be used in the modulation interference module 203, and the modulation interference module 203 comprises a 1×2 coupler integrated at the input and a 2×2 coupler integrated at the output as port devices for receiving and transmitting signal light respectively.

The light detection module includes a first balance detector 204 and a second balance detector 212, correspondingly, the fifth grating coupler 209 is a 2×2 optical coupler; the input of the first balance detector 204 is optically connected to the output of the optical modulation interference module 203, the input of the 2×2 optical coupler is optically connected to the output of the second splitting coupler 205 and the third port of the optical loop module 3 respectively, and the output of the 2×2 optical coupler is optically connected to the input of the second balance detector 212; and the first balance detector 204 and the second balance detector 212 convert the received optical signal into an electrical signal for external output.

The transmitting and receiving grating unit 211 is a single grating or grating array; where the grating array comprises a number of optical switches and a number of gratings, each grating converged via the optical path is optically connected to the second port of the optical loop module 3; and each optical switch 210 is set in the optical path between each grating and the second port of the optical loop module 3 to control the light transmission of the unique optical path between any grating and the second port of the optical loop module 3.

In the above embodiment, the first grating coupler 201 is configured as a beginning of the silicon photonic chip for receiving the signal light, and is directly connected to the outside for coupling the external signal light into the silicon photonic chip; the first splitting coupler 202 is connected to the first grating coupler 201, and is configured to transmit the split received signal light to the Mach-Zender interferometer and the second splitting coupler 205, respectively.

In this embodiment, the Mach-Zender interferometer has two optical waveguides with different lengths, and the Mach-Zender interferometer transmits the received signal light to the two optical waveguides with different lengths to generate interference and form the reference interference light, and the reference interference light is transmitted into the first balance detector 204, and is photoelectrically detected by the first balance detector 204 to form an electrical signal and output to the outside. At the same time, the Mach-Zender interferometer is also capable of modulating the phase of light through voltage. The second splitting coupler 205 splits the received signal light into a measurement light with most of the energy, for example, the received signal light is split into the measurement light and a local oscillation light with a ratio of 99:1 in energy. The local oscillation light is transmitted to the fifth grating coupler 209. Meanwhile, the measurement light is transmitted to the second grating coupler 206, and then transmitted to the optical switch 210 via the first and second ports of the optical circulator and the third grating coupler 207, and the optical switch 210 controls the connected transmitting and receiving grating unit 211 in a two-dimensional array to transmit the measurement light to the outside. The reflected light of a part of the measurement light from the outside is received by the transmitting and receiving grating unit 211 within the silicon photonic chip, transmitted to the fourth grating coupler 208 via the third grating coupler 207, and the second and third ports of the optical circulator, and then transmitted to the fifth grating coupler 209 via the on-chip waveguide to converge with the local oscillation light. The reflected light interferes with the local oscillation light to form the measurement interference light. The measurement interference light is transmitted into the second balance detector 212, and photoelectrically detected by the second balance detector 212 to form an electrical signal and output to the outside.

The waveguide integrated in the silicon body is used for connecting and transmitting, and is made of SiO₂, SiON or SiN material, which enables the signal light to be transmitted with very low loss in the silicon photonic chip, thus reducing the noise inside the chip and improving the stability and reliability of the optical components. The light detection module adopts a Ge detector, the preparation process of which is compatible with the silicon-based COMS process, and has the characteristics of flexible integration, low cost, and excellent optoelectronic performance. The light detection module is directly integrated into the silicon photonic chip, and is used to form the first balance detector 204 and the second balance detector 212 required for detecting signal light. The optical circulator can adopt a micro-crystal optical circulator, and its terminal face is coupled to the silicon photonic chip in an inverted cone structure through a micro-assembly process, such a structure not only improves the integration of the silicon photonic chip, but also makes use of the non-reciprocal characteristics of the optical circulator, thus enabling the optical circulator acts as an optical transceiver and constitutes a main optical component within the silicon photonic chip, and avoiding interference between beams of the signal light. The transmitting and receiving grating unit 211 may adopt a single grating or two-dimensional grating array which is formed from the optical path separated by a tree structure, such a design facilitates the control of the angle of the measurement light transmitted to the outside, and facilitates obtaining of the reflected light from external fixed sites or two-dimensional surfaces flexibly. In addition, the transmitting and receiving grating unit 211 integrates the transmitting and receiving grating into one unit, and miniaturizes the internal structure of the chip.

The silicon photonic chip provided in this embodiment integrates the beam splitter module, the light measurement interferometer module, the optical modulation interferometer module, and the optical detection module into the same silicon body to form a chip-level system for transmitting signal light, which improves the stability and reliability of each optical component, reduces the noise of the system, obtains a more compact chip integration system, and meets the current requirements for miniaturization of LiDAR.

Referring to FIG. 1, this embodiment also provides a silicon photonic chip-based LiDAR, comprising the above-described silicon photonic chip 2, a laser module, a beam collimator module 4, and a signal processing module 6, where the output of the laser module is optically connected to the input of the silicon photonic chip 2, and the electrical signal output of the silicon photonic chip 2 is electrically connected to the signal processing module 6 to process and analyze laser measurement information; the beam collimator module 4 is set on a side of the exit of the measurement light of the silicon photonic chip and allows the silicon photonic chip to be placed in the focal plane of the beam collimator module 4.

The laser module comprises a laser 101 and an isolator 102, where the laser 101 is optically connected to the silicon photonic chip 2 via the isolator 102; and the output of the laser 101 is frequency modulated continuous laser.

In the above embodiment, the laser 101 emits the frequency modulated continuous laser to the isolator 102, where a frequency modulation of the frequency modulated continuous laser is a triangular modulation, and the isolator 102 transmits the received laser to the first grating coupler 201 after the received laser being coupled by a transmission fiber, where the first grating coupler 201 is the beginning of the silicon photonic chip 2. Therefore, the laser is transmitted into the silicon photonic chip 2. The coupling and package of the first grating coupler 201 and the transmission fiber not only simplifies a layout of connection lines and improves an integration of the LiDAR system, but achieves a better transmission effect, due to the first grating coupler 201 transmits the laser from a larger diameter fiber into the silicon chip 2 with a smaller optical size.

The first grating coupler 201 transmits the received laser to the first splitting coupler 202, and the first splitting coupler 202 transmits the split received laser to the Mach-Zender interferometer and the second splitting coupler 205, respectively. The Mach-Zender interferometer splits the received reference light and transmits the split reference light to two waveguides with different lengths to generate interference and form a reference interference light. The reference interference light is transmitted into the first balance detector 204 and photoelectrically detected by the first balance detector 204 to form an electrical signal transmitted to the signal processing module 6, where the electrical signal is configured to correct a nonlinear error of the frequency modulated continuous laser. Meanwhile, the second splitting coupler 205 splits the received laser into a measurement light with most of the energy, for example, the received laser is split into the measurement light and a local oscillation light with a ratio of 99:1 in energy. The measurement light and the local oscillation light are transmitted in different optical paths. The local oscillation light is transmitted to the fifth grating coupler 209. The measurement light is transmitted to the second grating coupler 206, and then transmitted to the optical switch 210 via the first and second ports of the optical circulator and the third grating coupler 207, where the optical switch 210 controls a transmitting grating of the connected transmitting and receiving grating unit 211 in a two-dimensional array. The measurement light is then coupled to the beam collimator module 4 spatially through the transmitting grating, and then transmitted to a target 5 after being compressed a divergence angle by the beam collimator module. The receiving grating of transmitting and receiving grating unit 211 is coupled to the beam collimator module 4 spatially within the silicon photonic chip, and the receiving grating receives reflected light of a portion of the measurement light. The reflected light is transmitted to the fourth grating coupler 208 via the third grating coupler 207 and the second and third ports of the optical circulator, and then transmitted to the fifth grating coupler 209 via the on-chip waveguide to converge with the local oscillation light. The reflected light interferes with the local oscillation light to form a measurement interference light. The measurement interference light is transmitted into the second balance detector 212, and photoelectrically detected by the second balance detector 212 to form an electrical signal used for distance measurement and output to the signal processing module 6. Finally, the signal processing module 6 analyses and processes the electrical signal used for correcting nonlinear error and the electrical signal used for distance measurement to obtain the distance and speed of target 5.

The measurement light is diffusely reflected on the long-range target 5, and some of the diffusely reflected light is received by the beam collimator module 4 and transmitted into the transmitting and receiving grating unit 211, where the beam collimator module 4 is spatially coupled to the transmitting and receiving grating unit 211. If the transmitting and receiving grating unit 211 adopts single grating and then spatially couples to the beam collimator module 4, a measurement angle is fixed, therefore, the signal processing module 6 obtains the distance and speed of the target at a certain positioning site. If the transmitting and receiving grating unit 211 adopts a two-dimensional grating array, the grating of the two-dimensional grating array at different positions is located at different positions in the focal plane of the beam collimator module 4, the angles of emitted beams from the transmitting and receiving grating unit 211 can also change, and the position of emitted gratings of the measurement light can be controlled by the optical switch 210 to achieve two-dimensional scanning without any mechanical movement, therefore, the signal processing module 6 obtains the distance and speed of the target at a two-dimensional surface.

This embodiment provides a silicon photonic chip-based LiDAR. Compared to conventional LiDAR, the silicon photonic chip-based LiDAR greatly improves system integration, reduces system size and weight, improves system stability and reliability, reduces production costs, and eases assembly difficulties.

Finally, it should be noted that the above embodiments are only used to illustrate the technical schemes of the present disclosure without limitation. Although the present disclosure has been described in detail regarding the embodiments, those skilled in the art should understand that modifications or equivalent substitutions can be made to the technical schemes of the present disclosure without departing from the spirit and scope of the technical schemes of the present disclosure, and should be covered by the scope of the claims of the present disclosure.

What is claimed is:

1. A silicon photonic chip, comprising a silicon body in which a beam splitter module, a light measurement interference module, an optical modulation interference module (203), and a light detection module are integrated,
the beam splitter module is configured to receive an external input signal light and split the signal light to transmit them to the optical modulation interference module (203) and the light measurement interference module;
the light measurement interference module is configured to split the received signal light into a measurement light and a local oscillation light, and then receive a reflected light of a portion of the measurement light to interfere with the local oscillation light to form a measurement interference light after transmitting the measurement light to the outside;
the optical modulation interference module (203) splits the received signal light into a first reference light and a second reference light, and then combines and interferes the first reference light with the second reference light after adjusting the optical phase of the first reference light and/or the second reference light to form a reference interference light;
the light detection module receives the measurement interference light and the reference interference light respectively, and performs photoelectric conversion to output an electrical signal to the outside.

2. The silicon photonic chip according to claim 1, wherein the beam splitter module comprises a first grating coupler (201) and a first splitting coupler (202); the first grating coupler (201) is configured to receive the external input signal light, and the output of the first grating coupler (201) is optically connected to the input of the first splitting coupler (202); the output of the first splitting coupler (202) is optically connected to the input of the optical modulation interference module (203) and the light measurement interference module, respectively.

3. The silicon photonic chip according to claim 1 or 2, wherein the light measurement interference module comprises a second splitting coupler (205), an optical loop module (3), a fifth grating coupler (209) and a transmitting and receiving grating unit (211); the input of the second splitting coupler (205) is optically connected to the output of the first splitting coupler (202), the output of the second splitting coupler (205) is optically connected to a first port of the optical loop module (3) and to one of the inputs of the fifth grating coupler (209) respectively; a second port of the optical loop module (3) is optically connected to the input of the transmitting and receiving grating unit (211), a third port of the optical loop module (3) is optically connected to another input of the fifth grating coupler (209); the output of the fifth grating coupler (209) is optically connected to the input of the light detection module; and the transmitting and receiving grating unit (211) is configured to transmit the measurement light and to receive or transmit the reflected light of a portion of the measurement light.

4. The silicon photonic chip according to claim 3, wherein the transmitting and receiving grating unit (211) adopts a single grating.

5. The silicon photonic chip according to claim 3, wherein the transmitting and receiving grating unit (211) comprises a plurality of optical switches and a plurality of gratings, the plurality of gratings form a grating array; each grating converged via an optical path is optically connected to the second port of the optical loop module (3); and each optical switch (210) is set in the optical path between each grating and the second port of the optical loop module (3) to control the light transmission of the unique optical path between any grating and the second port of the optical loop module (3).

6. The silicon photonic chip according to claim 3, wherein the optical loop module (3) further comprises a second grating coupler (206), a third grating coupler (207), and a fourth grating coupler (208); the optical loop module (3) is optically connected to the second splitting coupler (205), the transmitting and receiving grating unit (211) and the fifth grating coupler (209) respectively through the second grating coupler (206), the third grating coupler (207) and the fourth grating coupler (208).

7. The silicon photonic chip according to claim 1, wherein the optical modulation of the optical modulation interference module (203) comprises one of electro-optic modulation, thermo-optic modulation, or acousto-optic modulation.

8. The silicon photonic chip according to claim 3, wherein the light detection module comprises a first balance detector (204) and a second balance detector (212), correspondingly, the fifth grating coupler (209) is a 2x2 optical coupler; the input of the first balance detector (204) is optically connected to the output of the optical modulation interference module (203), the input of the 2x2 optical coupler is optically connected to the output of the second splitting coupler (205) and the third port of the optical loop module (3) respectively, and the output of the 2x2 optical coupler is optically connected to the input of the second balance detector (212); and the first balance detector (204) and the second balance detector (212) convert the received optical signal into an electrical signal for external output.

9. A silicon photonic chip-based LiDAR, comprising a laser module, a beam collimator module (4), a signal processing module (6), and the silicon photonic chip according to any one of claims 1-8, wherein the output of the laser module is optically connected to the input of the silicon photonic chip, and the electrical signal output of the silicon photonic chip is electrically connected to the signal processing module (6) to process and analyze laser measurement information; and the beam collimator module (4) is set on a side of the exit of the measurement light of the silicon photonic chip and allows the silicon photonic chip to be placed in the focal plane of the beam collimator module (4).

10. The silicon photonic chip-based LiDAR according to claim 9, wherein the laser module comprises a laser (101) and an isolator (102), and the laser (101) is optically connected to the silicon photonic chip via the isolator (102); and the output of the laser (101) is frequency modulated continuous laser.
